(19) United States
(12) Patent Application Publication
(10) Pub. No.: US 2021/0226575 A1
(43) Pub. Date: Jul. 22, 2021

(54) Method using Embossing Tamper and Method for Earth Mount Utility Scale Photovoltaic Array

(71) Applicant: Erthos Inc., Tempe, AZ (US)

(72) Inventors: Frederick Morton TYLER, Browns Valley, CA (US); James Scott TYLER, Queen Creek, AZ (US); William T. HAMMACK, Taos, NM (US)

(21) Appl. No.: 17/152,663

(22) Filed: Jan. 19, 2021

Related U.S. Application Data
(60) Provisional application No. 62/963,300, filed on Jan. 20, 2020.

(51) Int. Cl. H02S 20/10; E02D 3/026

(52) U.S. Cl. CPC H02S 20/10; E02D 2200/17; E02D 3/026

(57) ABSTRACT

A site is prepared for the installation of solar panels by preparing a ground area by smoothing or grading and contouring to provide a surface sufficiently level to permit resting the solar panels in direct contact with and supported on the ground so as to establish an azimuth-independent earth orientation of the solar panels. The soil is embossed in a pattern corresponding to a desired pattern by repeatedly stamping the soil in a pattern with a soil stamping device capable of impressing the desired pattern on the soil. The pattern is sized such that the solar panels fit into the impressed pattern resulting from the embossing of the soil.

### RELATED APPLICATION(S)

The present Patent Application claims priority to Provisional Patent Application No. 62/963,300, filed Jan. 20, 2020, which is assigned to the assignee hereof and filed by the inventors hereof and which is incorporated by reference herein.

### BACKGROUND

### Technical Field

The disclosed technology relates to ground embossing using a ground embossing tamper, such as a tamping stamp or tamping roller, useful in preparing the ground for installation of preformed modules and modules requiring ground clearance for interconnection structures. The technology has particular application in ground preparation for mounting of solar panels using a terrestrial or ground-based mounting system.

### Background Art

Solar panels, also called solar modules, are assemblies of multiple photovoltaic (PV) cells hardwired together to form a single unit, typically as a rigid piece, although it is also possible to provide flexible solar panels. Groups of solar panels are aggregated into an array. The panels are also wired together to form a string, which are in turn connected to a power receiving unit, typically an inverter or other controller which provides an initial power output. One or more solar arrays form a solar plant.

A silicon based photovoltaic (PV) module, also commonly referred to as crystalline silicon (C_Si), is a packaged, connected assembly of typically 6×12 photovoltaic solar cells. For utility scale installations, the solar panels comprise a plurality of solar cells hardwired into a single unit, which is the module or panel. In a typical application, the panel is made up of component solar cells. In the above example of 6×12, this would be 72 solar cells, although this can vary significantly according to design choice. The individual solar cells may be fabricated in any convenient manner, and if desired can be separately fabricated and mounted onto a panel substrate or can be directly fabricated onto the substrate. There are other types of PV module technology in use today such as “thin film” and variations of silicon-based technology. Of the thin film, at least two module technologies stand out. The first is CdTe (cadmium telluride), also known as CadTel. The second is known as CIGS or CIS (copper, indium, gallium, selenium or simply copper, indium, selenium).

Several panels are connected together to form an array in a procedure called “stringing”. The number of panels making up a string can vary, but in a typical application, this can be 17-29 panels depending on both the environmental condition as well as the rated voltage of the module selected (string voltage). The size of an array is limited by power transmission limitations, including limiting maximum voltage and current at the array. The panels within an array are connected in one or more series and one or more parallel strings. A series string is a set of panels which are series connected to one another. This increases the power output of the string without a corresponding increase in current, but results in an increase in voltage. Since it is necessary to limit the maximum voltage output of the string as well as the maximum current output of the array, the array is often divided into multiple strings of a common voltage while summing the currents.

The number of panels in a string is given by way of non-limiting example, as this is a function of design considerations relating to panel voltage and related circuit parameters of the strings and arrays.

The arrays are in turn connected to power conversion and power transmission circuitry. This is accomplished by the internal connection of the solar cells within a panel, followed by connections between panels in an array, followed by connections to an inverter either directly or through wiring harnesses, which are typically situated beneath the panels. The inverter is the first circuit providing the output of the solar plant. The inverter is connected to further output circuitry, which is connected to transmission circuitry. The details can vary, for example for systems with local power connections, but in most solar power systems, the first connection for power conversion, distribution and transmission is the inverter. In other words, the strings are connected either directly or through wiring harness connections to the inverter.

The disclosed techniques seek to reduce the levelized cost of energy (LCOE) created by modern utility scale solar PV power plants. The utility scale solar PV power plant is unique from the many other forms of solar power electricity production. Due to the nature of the size, energy cost, safety, regulations, and operating requirements of utility scale power production, the components, hardware, design, construction means and methods, operations and maintenance all have both specific and unique features which afford them the designation “utility scale”.

Since the inception of PV technology, the technology has been an inherently expensive solution for power production. The PV cells contained within the heart of the solar modules have been both expensive to manufacture and relatively inefficient. Over the past 40 years, significant strides have been made on all fronts of PV cell and module manufacturing and technology, which have brought their price down to a point which has made the cost of solar based energy generation equal to and even less than all other forms of power generation in certain geographical areas.

When the technology was in its infancy, significant development was directed to handling and positioning the PV cells and their larger assemblies called modules. This development focused on what is now commonly referred to as “dual axis tracking”. This concept seeks to keep the PV cells at a position which is perpendicular to the impingement of the sun's rays—at all times through the day and the year. This method sought to extract the maximum energy from the cells in order to offset the very expensive cost.

As the price and efficiency of the cells and then modules improved, the costs of dual axis trackers became prohibitive relative to the cost of the panels. This resulted in the development two supplemental technologies now known as “fixed tilt” racking and “single axis tracking”. Further developments included adaptation for these newer systems to roof-top mounting on home, office, commercial and industrial buildings. Fixed tilt and single-axis tracking methods are often categorized as “ground mount” technologies which separate them from the “roof mount” technologies. The ground mount reference is simply that they are not associated with a building rather they are supported by free-standing structures with their own foundations.

Safety and regulatory requirements are generally applied to both secluded solar PV power plants and roof-top systems, but are different for utility scale solar photovoltaic power plants than for solar photovoltaic installations which are not in a protected area, as will be described. A utility scale PV power plant typically operates at 1500 volts DC for the module. These modules are not allowed in applications other than utility scale due to the regulatory requirements on the voltage (EMF). Specifically, exceeding 600 volts on the DC side places the system in a category which requires alternative safety, and operating requirements on the system. Examples include requiring a secured fence surrounding the power plant which doesn't allow the public with unfettered access to the higher voltages as well as specific training requirements and certifications for individuals who will be accessing the utility scale solar plant.

The operation of utility scale solar voltaic power plants is distinguished by typical operation at EMF exceeding 600 volts. This is established by a number of different code requirements, including the (US) National Electrical Code (NEC), the International Electrotechnical Commission[3] (IEC, or Commission éelectrotechnique internationale), and its affiliates. Electrical connections between enclosures exceeding 600 volts are required to be secured in an enclosure such as a room or fenced area which is restricted to trained or qualified personnel. For the purposes of this disclosure, such an enclosure will be described as a “protected area”. A non-limiting example of such a “protected area” is referenced in NEC Article 110, Part C, which provides the general requirements for over 600 volt applications. There can be variations in the voltage, as it is possible to design arrays that can safely operate at higher voltages in unprotected environments.

These distinctions are just two examples of what separate utility scale solar PV power plants from other approaches such as “solar roads”, or “personal use solar power devices”.

U.S. Pat. No. 10,826,426 A1, titled “Earth Mount Utility Scale Photovoltaic Array with Edge Portions Resting on Ground Support Area” describes photovoltaic arrays in which panels are placed on the ground for direct support on the ground without the need for racking systems. In placing such panels on the ground, it is desirable to prepare the ground in advance of placement of the panels. In some cases, it is desired to provide clearance for wiring harnesses and associated connection hardware.

### SUMMARY

A site for the installation of solar panels, such as photovoltaic solar panels, is prepared prior to the installation of the panels. A ground area is prepared by smoothing or grading and contouring to provide a surface sufficiently level to permit resting the solar panels in direct contact with and supported on the ground, or supported on the ground through an interstitial layer by supporting the solar panels or edge frames of the solar panels. The support on the ground establishes an azimuth-independent earth orientation of the solar panels and positioned in a closely-adjacent arrangement or an abutting arrangement of plural rows of the solar panels, wherein the array of solar panels achieve contact without an intermediate structure other than an interstitial layer between the solar panels and the ground for structural support. The soil on the ground area is embossed in a pattern corresponding to a desired pattern of soil beneath the solar panels, by repeatedly stamping the soil in a pattern with a soil stamping device. The soil stamping device is capable of impressing the desired pattern on the soil, with the pattern sized such that the solar panels fit into the impressed pattern resulting from the embossing of the soil. At least a subset of the solar panels are on the ground by direct contact with the ground or supported on the ground through an interstitial layer by supporting the solar panels or edge frames of the solar panels.

A tamper for preparing a site for the installation of solar panels comprises a tamping form having ridges corresponding to predetermined portions of the solar panels. The ridges create embossed depressions in the ground corresponding to predetermined portions of the solar panels edge frames of the solar panels upon tamping engagement by the tamping form on the ground at the site, the predetermined portions comprising solar panel structures and related solar panel array hardware, such as edge frames, harness connectors and harness cabling. The tamping form is driven by a tamping driver capable of applying pressure on the ground through the tamping form for said creating embossed depressions in the ground.

### BRIEF DESCRIPTION OF THE DRAWINGS

FIG. 1 is a schematic diagram showing a partial layout of a solar array for a commercial solar power plant.

FIGS. 2A-2C are schematic diagrams showing a spring clip arrangement for mechanically linking solar panels. FIG. 2A shows a spring clip. FIG. 2B shows the attachment of the clip to a module, and FIG. 2C shows the connection of two modules with the clip.

FIG. 3 is a schematic diagram showing a corner bracket arrangement for mechanically linking solar panels.

FIG. 4 is a schematic diagram showing a solar panel 201 with its edge frame 205 resting on the ground.

FIG. 5 is a diagram showing a tamping device in the form of a tamping roller.

FIG. 6 is a diagram showing a tamping device in the form of a tamping roller with additional ridges corresponding to edge frames, junction boxes and wire ways found on solar panels.

FIG. 7 is a schematic diagram of a horizontal tamping form.

FIG. 8 is a schematic diagram showing the use of tamper to create a repeat pattern in the ground

### DETAILED DESCRIPTION

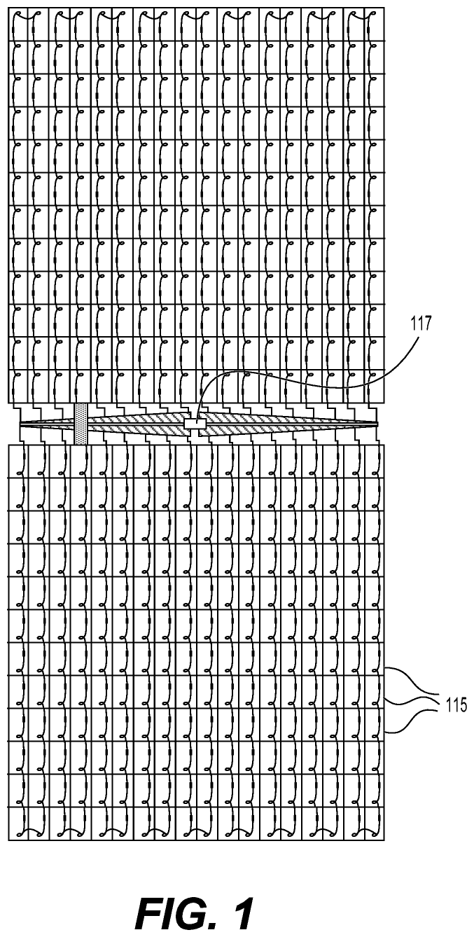

FIG. 1 is a schematic diagram showing a partial layout of a solar array for a commercial solar power plant, comprising multiple solar panels 115. Shown is a string array comprising 18 strings with each string containing 24 modules connected in series within that string and a string inverter 117 depicted in the center. The inverter 117 is connected to the strings for purposes of converting the DC power from the strings to AC power. Multiple string arrays and inverters are connected to establish a complete solar array. A utility scale solar power plant typically comprises 1 or more of these arrays.

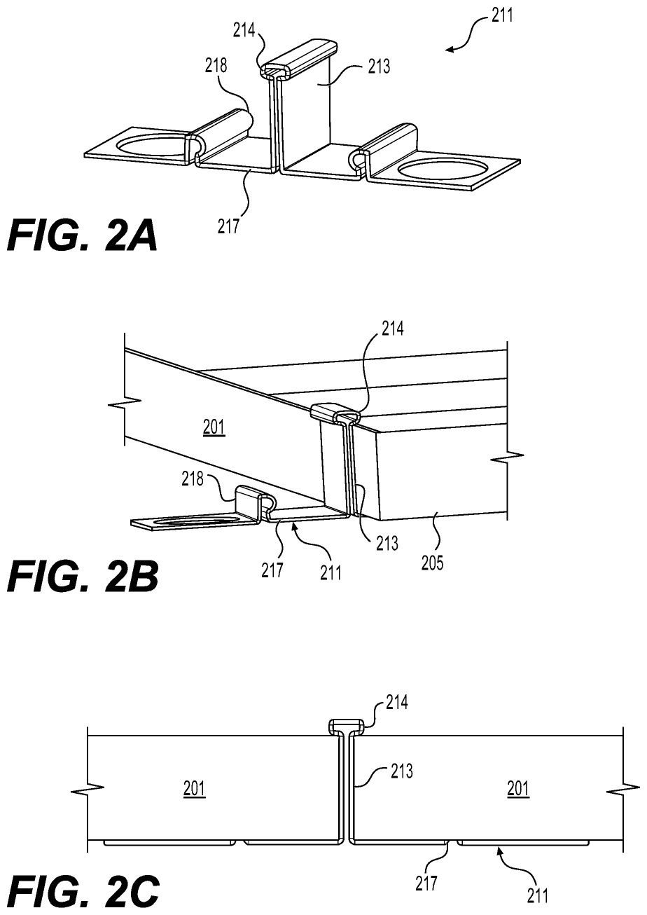

FIGS. 2A-2C are schematic diagrams showing a spring clip arrangement for mechanically linking solar panels 201. In this non-limiting example, solar panels 201 have edge frames 205, which conveniently permit attachment of supporting brackets. FIG. 2A shows a spring clip 211. FIG. 2B shows the attachment of the clip to a module 201. FIG. 2C shows the connection of two modules 201 with the clip 211. Spring clip 211 comprises a flat sheet, folded to outer frame support 213 (for the outer frame sides of solar panels 201), with raised retainer lips 214, and two inner frame supports 217 (for inner frame edges of the solar panels 201), with raised retainer lips 218. The spring clip arrangement holds panels 201 with a fixed gap between panels, and in a fixed alignment with each other.

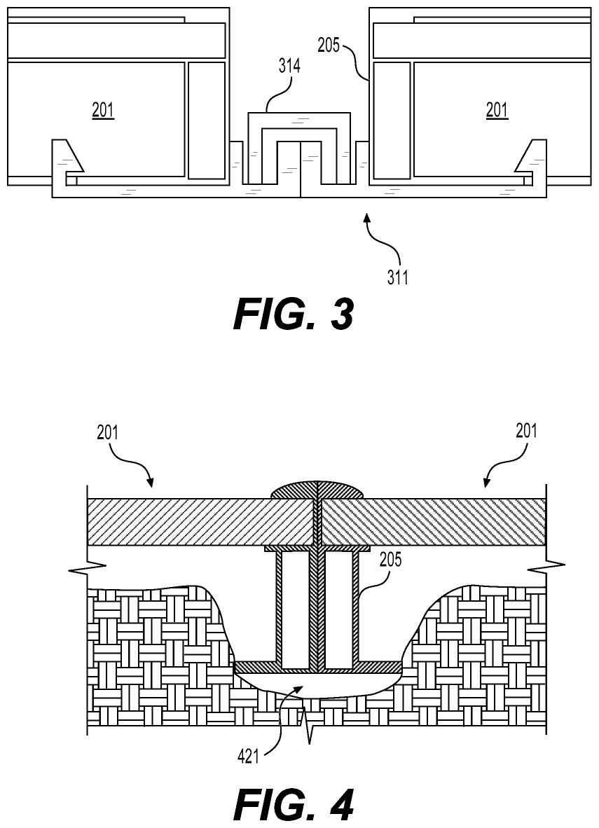

FIG. 3 is a schematic diagram showing a corner bracket arrangement for mechanically linking solar panels 201. Corner brackets 311 receives edge frames 205 of the panels 201, with clamp flanges 314 engaging linking flanges 315 on brackets 311, and the arrangement holds panels 201 with a fixed gap between panels.

It is also possible to place panels 201 directly on the ground without clamps, but with the panels 201 positioned with a fixed gap between panels or with no substantial gap between panels 201.

The earth oriented mounting lends to directly placing the panels on the ground without the use of corner brackets or other external bracing. In the case of solar panels with frames, the frame can be rested on the ground, which, in turn, provides mechanical support for the panels. FIG. 4 is a schematic diagram showing a solar panels 201 with edge frames 205 resting on the ground.

Referring to FIG. 4, the ground is prepared by generally smoothing the ground to desired contours for the panels 201. Furrows 421 are dug or impressed by mechanical means, and the panels 201 are placed on the ground with their edge frames 205 resting against the sides of furrows 421. Furrows 421 serve to positionally stabilize the panels 201, and provide the mechanical support for the panels 201. While it is possible for the panels 201 to directly rest on the ground on parts of the panels 201 other than the edge frames 205, the support by the frames 205 reduces mechanical force applied to the active parts of the panels 201 and leaves additional room for electrical connections. Thus, furrows 421 are formed as grooves, depressions or channels dug into the ground to receive the edge frames 205.

Furrows 421 are given by way of non-limiting example. In many installations, it is possible to directly support the panels 201 or the edge frames 205 directly on the ground without digging furrows. In some soil conditions, the edge frames 205 will sink into the soil, whereas in other conditions, the edge frames 205 will remain substantially at the top surface of the ground. It is further expected that the panels 201 will rest against the ground without the use of the edge frames 205, either because the edge frames 205 are allowed to sink below a level at which the panels will rest on the ground, or in cases in which panels are constructed without edge frames.

Prior to positioning the panels 201 on the ground, the ground is prepared by smoothing or grading and contouring to provide a surface sufficiently level to permit resting the solar panels in direct contact or upon an interstitial layer. The ground preparation may also include tilling the ground.

The support can be by supporting the solar panels 201 directly, or by supporting the panels with edge frames 205 of the solar panels. The support establishes an azimuth-independent earth orientation of the solar panels and positioned in a closely-adjacent arrangement or an abutting arrangement of plural rows of the solar panels 201. As a result, the array of solar panels is directly supported by the ground without an intermediate structure other than an optional interstitial layer between the solar panels and the ground.

The soil at the ground area is embossed in a pattern corresponding to a desired pattern of soil beneath the solar panels, shaped by repeatedly stamping the soil in a pattern with a soil stamping device. The soil stamping device is capable of impressing the desired pattern on the soil, and the pattern is sized such that the solar panels fit into an embossed stamp resulting from the embossing of the soil.

After embossing, the solar panels 201 are placed on the ground by direct contact with the ground or supported on the ground through an interstitial layer by supporting the solar panels or edge frames of the solar panels.

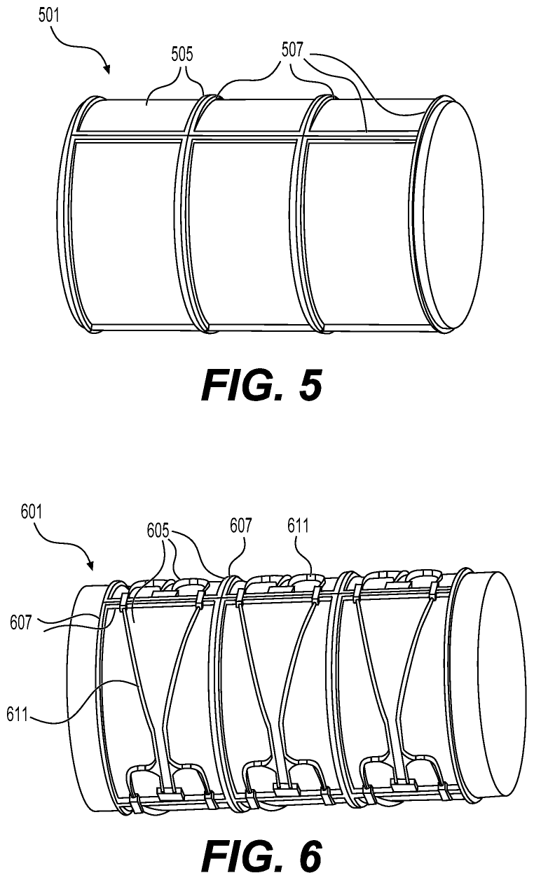

FIG. 5 is a diagram showing a tamping device in the form of a tamping roller 501. Tamping roller 501 has a cylindrical surface 505, with raised ridges 507. Surface 505 with raised edges engages the ground as a tamping form. The spacing of raised ridges 507 corresponds to the physical size of panels 201 (FIG. 2), and the spacing of panels 201 in the array. The spacing of panels 201 is established as mechanically fixed to each other, for example, by spring clips 211. Alternatively, the spacing of panels 201 is established by the pattern of the tamping device itself. In this non-limiting example, ridges 507 accommodate edge frames 205.

FIG. 6 is a diagram showing a tamping device, also in the form of a tamping roller 601, having additional ridges or raised portions corresponding to edge frames, junction boxes and wire ways found on solar panels. Tamping roller 601 has a surface 605 having raised portions which engage the ground as a tamping form. Tamping roller 601 has ridges 607 corresponding to edge frames 205 on panels 201 (FIG. 2). Additionally ridges 611 for junction boxes and wire leads of the modules are provided, which emboss the soil in order to provide clearance for these components. Ridges 607 and harnessing connector ridges 611 form some or all of the raised ridges on surface 605.

The embossing can be used for solar panels with or without edge frames 205. In the case of panels without edge frames, the embossing can be used to allow the panels 201 to rest directly on the ground. The embossed features can correspond to portions of the solar panels 201 corresponding to one or more of edge frames, harness connectors and harness cabling, although other features of the solar array hardware can be accommodated. It is alternatively possible to configure the tamping roller to create a recess for each entire panel 201, with or without further embossing for the harness connectors.

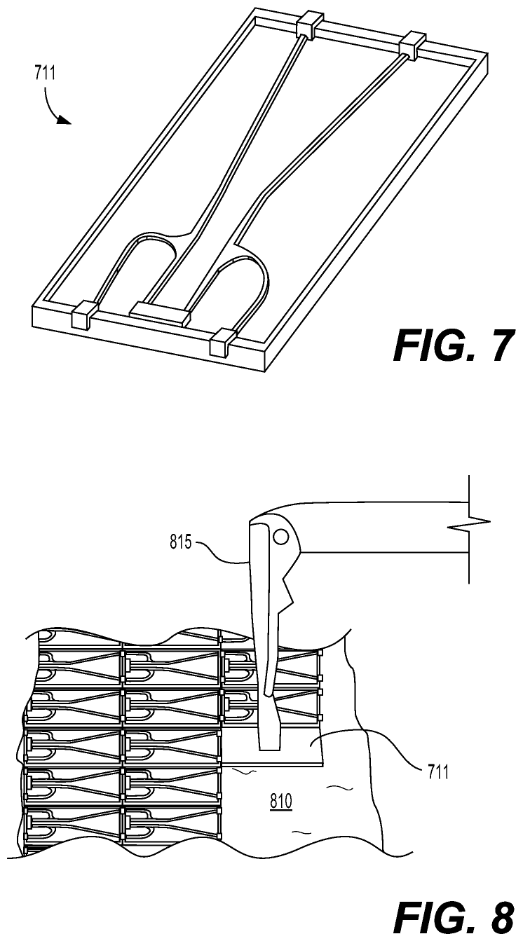

FIG. 7 is a schematic diagram of a horizontal tamping form 711 of a tamper. Horizontal tamping form 711 is incrementally moved to progressively emboss the soil, with spacing determined by a sequence of movement and stamping sequential regions of the ground.

The tamping may be achieved by any of a variety of tamping machines, using conventional tamping drivers. This can, by way of non-limiting examples, include applying pressure by weight, by vibration or impulse. FIG. 8 is a schematic diagram showing the use of tamping form 711 to create a repeat pattern in the ground for accepting an array of photovoltaic solar panels. Tamping form 711 is used to impress the pattern on the ground 810 by use of a ground tamping crane 815.

Closing Statement

It will be understood that many additional changes in the details, materials, steps and arrangement of parts, which have been herein described and illustrated to explain the nature of the subject matter, may be made by those skilled in the art within the principle and scope of the invention as expressed in the appended claims.

What is claimed is:

1. A method for preparing a site for the installation of solar panels, the method comprising:
preparing a ground area, said preparing comprising smoothing or grading and contouring to provide a surface sufficiently level to permit resting the solar panels in direct contact with and supported on the ground or supported on the ground through an interstitial layer by supporting the solar panels or edge frames of the solar panels so as to establish an azimuth-independent earth orientation of the solar panels and positioned in a closely-adjacent arrangement or an abutting arrangement of plural rows of the solar panels, wherein the array of solar panels achieve contact without an intermediate structure other than an interstitial layer between the solar panels and the ground for structural support;
embossing soil at the ground area in a pattern corresponding to a desired pattern of soil beneath the solar panels, by repeatedly stamping the soil in a pattern with a soil stamping device capable of impressing the desired pattern on the soil, the pattern sized such that the solar panels fit into the impressed pattern resulting from the embossing of the soil; and
placing at least a subset of the solar panels on the ground by direct contact with the ground or supported on the ground through an interstitial layer by supporting the solar panels or edge frames of the solar panels.

2. The method of claim 1, wherein the preparing a ground area comprises creating a loose soil condition using a soil tilling technique.

3. The method of claim 1, wherein the preparing a ground area comprises:
in cases in which the soil condition precludes embossing, creating a loose soil condition using a soil tilling technique; and
in cases in which the soil condition permits embossing, preparing the ground area without fully tilling the soil.

4. The method of claim 1, further comprising:
using a cylindrical or drum roller as the soil stamping device.

5. The method of claim 1, further comprising:
using a flat stamp as the soil stamping device.

6. The method of claim 1, further comprising:
embossing the soil with a pattern that comprises shapes for module wires and a module junction box for the respective solar panels, allowing for placements of components having those shapes when installing the solar panels.

7. A tamper for preparing a site for the installation of solar panels comprising:
a tamping form having ridges corresponding to predetermined portions of the solar panels, the ridges creating embossed depressions in the ground corresponding to predetermined portions of the solar panels edge frames of the solar panels upon tamping engagement by the tamping form on the ground at the site, the predetermined portions comprising solar panel structures and related solar panel array hardware chosen from the group consisting of one or more of edge frames, harness connectors and harness cabling; and
a tamping driver capable of applying pressure on the ground through the tamping form for said creating embossed depressions in the ground.

8. The tamper of claim 7, further comprising:
a tamping roller having a surface comprising the tamping form.

9. The tamper of claim 7, further comprising:
a tamping machine driving the tamping form to cause said tamping engagement by applying pressure by weight, by vibration or impulse.

10. A method for installing an array of solar panels, the method comprising:
a step of preparing a ground area, said preparing comprising smoothing or grading and contouring to provide a surface sufficiently level to permit resting the solar panels in direct contact with and supported on the ground or supported on the ground through an interstitial layer by supporting the solar panels or edge frames of the solar panels so as to establish an azimuth-independent earth orientation of the solar panels and positioned in a closely-adjacent arrangement or an abutting arrangement of plural rows of the solar panels, wherein the array of solar panels achieve contact without an intermediate structure other than an interstitial layer between the solar panels and the ground for structural support;
a step of embossing soil at the ground area in a pattern corresponding to a desired pattern of soil beneath the solar panels, by repeatedly stamping the soil in a pattern with a soil stamping device capable of impressing the desired pattern on the soil, the pattern sized such that the solar panels fit into the impressed pattern resulting from the embossing of the soil; and
a step of placing at least a subset of the solar panels on the ground by direct contact with the ground or supported on the ground through an interstitial layer by supporting the solar panels or edge frames of the solar panels.

11. The method of claim 10, wherein the preparing a ground area comprises creating a loose soil condition using a soil tilling technique.

12. The method of claim 10, wherein the preparing a ground area comprises:
in cases in which the soil condition precludes embossing, creating a loose soil condition using a soil tilling technique; and
in cases in which the soil condition permits embossing, preparing the ground area without fully tilling the soil.

13. The method of claim 10, further comprising:
using a cylindrical or drum roller as the soil stamping device.

14. The method of claim 10, further comprising:
using a flat stamp as the soil stamping device.

15. The method of claim 10, further comprising:
embossing the soil with a pattern that comprises shapes for module wires and a module junction box for the respective solar panels, allowing for placements of components having those shapes when installing the solar panels.
